(19) United States
(12) Patent Application Publication
(10) Pub. No.: US 2026/0118815 A1
(43) Pub. Date: Apr. 30, 2026

(54) DRIVER AND IMAGE FORMING APPARATUS

(71) Applicant: Hiroaki TAKAGI, Kanagawa (JP)

(72) Inventor: Hiroaki TAKAGI, Kanagawa (JP)

(73) Assignee: Ricoh Company, Ltd., Tokyo (JP)

(21) Appl. No.: 19/285,452

(22) Filed: Jul. 30, 2025

(30) Foreign Application Priority Data
Oct. 28, 2024 (JP) 2024-189162
May 15, 2025 (JP) 2025-081621

(51) Int. Cl. G03G 15/00; F16H 1/28; F16H 57/021; F16H 57/08

(52) U.S. Cl. CPC G03G 15/757; F16H 1/28; F16H 57/021; F16H 57/082

(57) ABSTRACT

A driver includes a sun gear and a driving source that drives and rotates the sun gear. A planetary gear meshes with the sun gear. An internal gear meshes with the planetary gear. An output shaft has a central axis that is coaxially aligned with a central axis of each of the sun gear and the internal gear. A carrier supports the planetary gear rotatably and is combined with the output shaft. A first bearing supports the output shaft rotatably. A first holder includes an inner circumferential portion that supports the first bearing non-rotatably and an outer circumferential portion that supports the internal gear non-rotatably. A second bearing is separated from the driving source farther than the first bearing is. The second bearing supports the output shaft rotatably. A second holder supports the driving source and the first bearing non-rotatably. The second holder supports the second bearing.

### CROSS-REFERENCE TO RELATED APPLICATIONS

This patent application is based on and claims priority pursuant to 35 U.S.C. § 119 (a) to Japanese Patent Application Nos. 2024-189162, filed on Oct. 28, 2024, and 2025-081621, filed on May 15, 2025, in the Japan Patent Office, the entire disclosure of each of which is hereby incorporated by reference herein.

### BACKGROUND

### Technical Field

The present disclosure relates to a driver and an image forming apparatus, and more particularly, to a driver for driving and rotating a driven body and an image forming apparatus incorporating the driver.

### Related Art

Related-art image forming apparatuses, such as copiers, printers, facsimile machines, and multifunction peripherals (MFP) having two or more of copying, printing, scanning, facsimile, plotter, and other functions, typically form an image on a recording medium according to image data.

Such image forming apparatuses include a driver that drives and rotates a driven body such as a photoconductive drum.

### SUMMARY

The present disclosure described herein provides a driver including a sun gear and a driving source that drives and rotates the sun gear. A planetary gear meshes with the sun gear. An internal gear meshes with the planetary gear. An output shaft has a central axis that is coaxially aligned with a central axis of each of the sun gear and the internal gear. A carrier supports the planetary gear rotatably and is combined with the output shaft. A first bearing supports the output shaft rotatably. A first holder includes an inner circumferential portion that supports the first bearing non-rotatably and an outer circumferential portion that supports the internal gear non-rotatably. A second bearing is separated from the driving source farther than the first bearing is. The second bearing supports the output shaft rotatably. A second holder supports the driving source and the first bearing non-rotatably. The second holder supports the second bearing.

The present disclosure described herein further provides a driver including a driving motor that generates a driving force and includes a motor shaft. A mounting plate mounts the driving motor stationarily. An output shaft has a center of rotation disposed on a substantially identical, hypothetical straight line shared with a center of rotation of the motor shaft of the driving motor. A gear reducer decreases a rotational speed of the driving motor and transmits the driving force generated by the driving motor to the output shaft. A first bearing supports the output shaft rotatably. A first holder includes an inner circumferential portion that supports the first bearing non-rotatably and an outer circumferential portion that supports the gear reducer non-rotatably. A second bearing is separated from the driving motor farther than the first bearing is. The second bearing supports the output shaft rotatably. A second holder supports the mounting plate and one of the first bearing, the first holder, and the gear reducer non-rotatably. The second holder supports the second bearing.

The present disclosure described herein further provides an image forming apparatus including a driven body and the driver described above that drives and rotates the driven body.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a cross-sectional view of an image forming apparatus according to an embodiment of the present disclosure, illustrating an entire construction of the image forming apparatus;

FIG. 2 is a partially enlarged view of an image forming device incorporated in the image forming apparatus depicted in FIG. 1;

FIG. 3 is a schematic cross-sectional view of an intermediate transfer belt device, a secondary transfer belt device, and a periphery thereof, that are incorporated in the image forming apparatus depicted in FIG. 1;

FIG. 4A is an exploded view of a photoconductive drum incorporated in the image forming device depicted in FIG. 2;

FIG. 4B is a cross-sectional view of a drum shaft that mounts the photoconductive drum depicted in FIG. 4A;

FIG. 5 is a cross-sectional view of the image forming apparatus depicted in FIG. 1, illustrating the drum shaft that mounts the photoconductive drum, an output shaft of a driver, and a joint that couples the drum shaft with the output shaft;

FIG. 6 is a cross-sectional view of the driver incorporated in the image forming apparatus depicted in FIG. 2;

FIG. 7 is a perspective view of the driver depicted in FIG. 6;

FIG. 8 is an exploded view of the driver depicted in FIG. 7, illustrating a part thereof;

FIG. 9 is a cross-sectional view of a driver as a first modification example of the driver depicted in FIG. 6;

FIG. 10 is a cross-sectional view of a driver as a second modification example of the driver depicted in FIG. 6;

FIG. 11 is a cross-sectional view of a driver as a third modification example of the driver depicted in FIG. 6;

FIG. 12 is a cross-sectional view of a driver as a fourth modification example of the driver depicted in FIG. 6;

FIG. 13 is a cross-sectional view of a driver as a variation of the driver depicted in FIG. 12;

FIG. 14 is a cross-sectional view of a driver as a fifth modification example of the driver depicted in FIG. 6;

FIG. 15 is a cross-sectional view of a driver as a sixth modification example of the driver depicted in FIG. 6;

FIG. 16 is a cross-sectional view of a driver as a seventh modification example of the driver depicted in FIG. 6; and

FIG. 17 is a cross-sectional view of a driver as an eighth modification example of the driver depicted in FIG. 6.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

The following describes embodiments of the present disclosure in detail with reference to drawings. In the drawings, identical reference numerals are assigned to identical elements or equivalents and redundant descriptions of the identical elements or the equivalents are summarized or omitted properly.

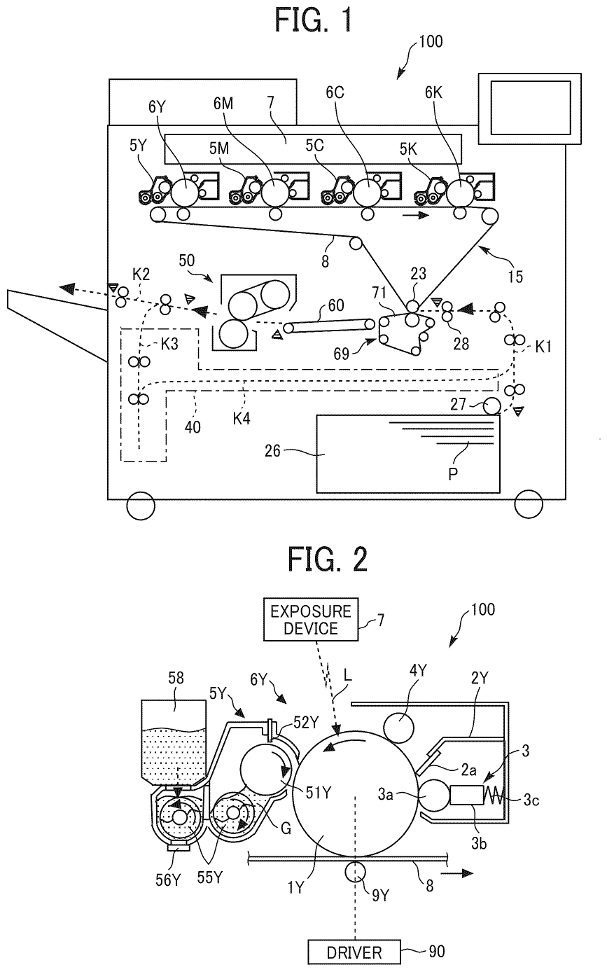

Referring to FIGS. 1 and 2, a description is provided of an entire construction and operations of an image forming apparatus 100.

FIG. 1 is a diagram of a printer as the image forming apparatus 100, illustrating a construction thereof. FIG. 2 is an enlarged view of a part of an image forming device of the image forming apparatus 100.

As illustrated in FIG. 1, the image forming apparatus 100 includes an intermediate transfer belt 8 that is disposed in a center of the image forming apparatus 100. The image forming apparatus 100 further includes image forming devices 6Y, 6M, 6C, and 6K that form yellow, magenta, cyan, and black toner images, respectively, and are arranged. The image forming devices 6Y, 6M, 6C, and 6K are disposed opposite the intermediate transfer belt 8.

The image forming apparatus 100 further includes a control panel (e.g., a control-display portion) that is disposed in an upper portion of the image forming apparatus 100. The control panel displays data relating to printing (e.g., image formation). A user controls operations of the image forming apparatus 100 with the control panel.

As illustrated in FIG. 2, the image forming device 6Y that forms the yellow toner image includes a photoconductive drum 1Y (e.g., a photoconductor) serving as a driven body. The image forming device 6Y further includes a charger 4Y, a developing device 5Y, a cleaner 2Y, a lubricant supply 3, and a discharger that surround the photoconductive drum 1Y. Image forming processes (e.g., a charging process, an exposure process, a developing process, a primary transfer process, a cleaning process, and a discharging process) are performed on the photoconductive drum 1Y, forming the yellow toner image on the photoconductive drum 1Y.

Although other three image forming devices 6M, 6C, and 6K use toners in different colors, respectively, the image forming devices 6M, 6C, and 6K have constructions that are equivalent to a construction of the image forming device 6Y that forms the yellow toner image, thus forming the magenta, cyan, and black toner images, respectively. The following describes the construction of the image forming device 6Y that forms the yellow toner image, properly omitting descriptions of the constructions of other three image forming devices 6M, 6C, and 6K, respectively.

As illustrated in FIG. 2, the image forming apparatus 100 further includes a driver 90 including a driving motor that drives and rotates the photoconductive drum 1Y counterclockwise in FIG. 2, an exposure device 7, and a primary transfer roller 9Y. The charger 4Y uniformly charges a surface of the photoconductive drum 1Y at an opposed position where the photoconductive drum 1Y is disposed opposite the charger 4Y in the charging process.

Thereafter, a charged portion on the surface of the photoconductive drum 1Y reaches an irradiation position where the exposure device 7 irradiates the photoconductive drum 1Y with a laser beam L. The laser beam L scans and exposes the surface of the photoconductive drum 1Y in a width direction (e.g., a direction perpendicular to a paper surface in FIGS. 1 and 2 or a main scanning direction) at the irradiation position, forming an electrostatic latent image according to yellow image data in the exposure process.

Thereafter, the surface of the photoconductive drum 1Y reaches an opposed position where the photoconductive drum 1Y is disposed opposite the developing device 5Y. The developing device 5Y develops the electrostatic latent image into a yellow toner image at the opposed position in the developing process.

Thereafter, the yellow toner image formed on the surface of the photoconductive drum 1Y reaches an opposed position where the photoconductive drum 1Y is disposed opposite the primary transfer roller 9Y via the intermediate transfer belt 8. At the opposed position, the primary transfer roller 9Y primarily transfers the yellow toner image formed on the surface of the photoconductive drum 1Y onto a surface of the intermediate transfer belt 8 in the primary transfer process. A slight amount of residual, untransferred toner that is failed to be transferred onto the intermediate transfer belt 8 remains on the photoconductive drum 1Y.

Thereafter, the surface of the photoconductive drum 1Y reaches an opposed position where the photoconductive drum 1Y is disposed opposite the cleaner 2Y. The cleaner 2Y includes a cleaning blade 2a. At the opposed position, the cleaning blade 2a collects the residual toner failed to be transferred onto the intermediate transfer belt 8 and therefore remaining on the photoconductive drum 1Y into the cleaner 2Y in the cleaning process.

The lubricant supply 3 is disposed inside the cleaner 2Y. The lubricant supply 3 (e.g., a lubricant supply for the photoconductor) includes a lubricant supply roller 3a, a solid lubricant 3b, and a compression spring 3c. As the lubricant supply roller 3a rotates clockwise in FIG. 2, the lubricant supply roller 3a scrapes a lubricant off the solid lubricant 3b gradually. Thus, the lubricant supply roller 3a supplies the lubricant onto the surface of the photoconductive drum 1Y.

Finally, the surface of the photoconductive drum 1Y reaches an opposed position where the photoconductive drum 1Y is disposed opposite the discharger. At the opposed position, the discharger removes residual potential on the photoconductive drum 1Y.

Thus, a series of image forming processes performed on the photoconductive drum 1Y finishes.

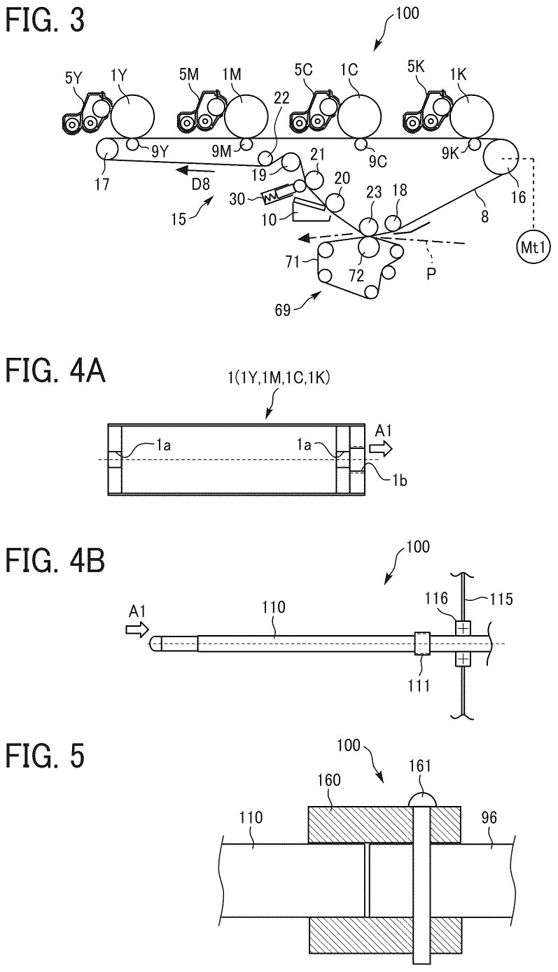

Each of other image forming devices 6M, 6C, and 6K also performs the image forming processes described above similarly to the image forming device 6Y that forms the yellow toner image. For example, the exposure device 7 disposed above the image forming devices 6Y, 6M, 6C, and 6K emits laser beams L according to image data onto photoconductive drums 1M, 1C, and 1K depicted in FIG. 3 of the image forming devices 6M, 6C, and 6K, respectively. Specifically, the exposure device 7 includes a light source, a polygon mirror, and a plurality of optical elements. The light source emits the laser beams L. The polygon mirror that is driven and rotated causes the laser beams L to irradiate and scan the surfaces of the photoconductive drums 1Y, 1M, 1C, and 1K through the optical elements, respectively. Alternatively, the exposure device 7 may include a plurality of light-emitting diodes (LEDs) that is arranged in a width direction of the exposure device 7.

Thereafter, the magenta, cyan, and black toner images formed by developing devices 5M, 5C, and 5K of the image forming devices 6M, 6C, and 6K on the photoconductive drums 1M, 1C, and 1K, respectively, in the developing process are primarily transferred onto the intermediate transfer belt 8 such that the yellow, magenta, cyan, and black toner images are superimposed on the intermediate transfer belt 8. Thus, a color toner image is formed on the intermediate transfer belt 8.

As illustrated in FIG. 3, the intermediate transfer belt 8 is stretched across and supported by a plurality of rollers, that is, a driving roller 16, a driven roller 17, a pre-transfer roller 18, a tension roller 19, a cleaner opposed roller 20, a lubricant opposed roller 21, a backup roller 22, and a secondary transfer opposed roller 23. As a motor drives and rotates one of the rollers, that is, the driving roller 16, the driving roller 16 rotates the intermediate transfer belt 8 serving as an endless belt in a rotation direction D8 indicated by arrow in FIG. 3.

The image forming apparatus 100 further includes primary transfer rollers 9M, 9C, and 9K. The four primary transfer rollers 9Y, 9M, 9C, and 9K and the photoconductive drums 1Y, 1M, 1C, and 1K sandwich the intermediate transfer belt 8 to form primary transfer nips between the photoconductive drums 1Y, 1M, 1C, and 1K and the intermediate transfer belt 8, respectively. Each of the primary transfer rollers 9Y, 9M, 9C, and 9K is applied with a transfer voltage (e.g., a primary transfer bias) having a polarity opposite to a polarity of toner.

The intermediate transfer belt 8 rotates in the rotation direction D8 and passes through the primary transfer nips formed by the primary transfer rollers 9Y, 9M, 9C, and 9K successively. Accordingly, the primary transfer rollers 9Y, 9M, 9C, and 9K primarily transfer the yellow, magenta, cyan, and black toner images formed on the photoconductive drums 1Y, 1M, 1C, and 1K, respectively, onto the intermediate transfer belt 8 in the primary transfer process such that the yellow, magenta, cyan, and black toner images are superimposed on the surface of the intermediate transfer belt 8.

The image forming apparatus 100 further includes a secondary transfer belt 71, a secondary transfer roller 72, an intermediate transfer belt cleaner 10, and a lubricant supply 30. Thereafter, the yellow, magenta, cyan, and black toner images primarily transferred and superimposed on the intermediate transfer belt 8 reach an opposed position where the intermediate transfer belt 8 is disposed opposite the secondary transfer belt 71. At the opposed position, the secondary transfer opposed roller 23 and the secondary transfer roller 72 sandwich the intermediate transfer belt 8 and the secondary transfer belt 71 to form a secondary transfer nip between the intermediate transfer belt 8 and the secondary transfer belt 71. The secondary transfer roller 72 secondarily transfers the toner images in four colors, that is, the yellow, magenta, cyan, and black toner images, formed on the intermediate transfer belt 8 onto a sheet P (e.g., paper) conveyed to the secondary transfer nip in a secondary transfer process. Residual, untransferred toner failed to be transferred onto the sheet P remains on the intermediate transfer belt 8.

Thereafter, the residual toner on the intermediate transfer belt 8 reaches an opposed position where the intermediate transfer belt 8 is disposed opposite the intermediate transfer belt cleaner 10. At the opposed position, the intermediate transfer belt cleaner 10 removes an adhered substance such as the untransferred toner adhered to the surface of the intermediate transfer belt 8 therefrom.

A transferred portion on the surface of the intermediate transfer belt 8, from which the color toner image is transferred, reaches an opposed position where the intermediate transfer belt 8 is disposed opposite the lubricant supply 30 serving as an intermediate transfer lubricant supply. At the opposed position, the lubricant supply 30 supplies a lubricant onto the surface of the intermediate transfer belt 8.

Thus, a series of transfer processes performed on the intermediate transfer belt 8 finishes.

As illustrated in FIG. 1, the image forming apparatus 100 further includes a sheet feeder 26, a feed roller 27, a registration roller pair 28, a first conveyance path K1, a conveyance belt 60, and a fixing device 50. The sheet P conveyed to the secondary transfer nip is conveyed from the sheet feeder 26 disposed in a lower portion of an apparatus body of the image forming apparatus 100 through the feed roller 27, the registration roller pair 28, and the like.

For example, the sheet feeder 26 loads a plurality of sheets P (e.g., transfer sheets) stacked therein. As the feed roller 27 is driven and rotated counterclockwise in FIG. 1, the feed roller 27 feeds an uppermost sheet P to a roller nip formed between rollers of the registration roller pair 28 through the first conveyance path K1.

The registration roller pair 28 (e.g., a timing roller pair) that interrupts rotation temporarily halts the sheet P conveyed to the registration roller pair 28 at the roller nip of the registration roller pair 28. The registration roller pair 28 resumes rotation and conveys the sheet P to the secondary transfer nip at a time when the sheet P meets the color toner image formed by the yellow, magenta, cyan, and black toner images superimposed on the intermediate transfer belt 8 at the secondary transfer nip. The secondary transfer roller 72 transfers the desired color toner image onto the sheet P.

Thereafter, the secondary transfer belt 71 conveys the sheet P transferred with the color toner image at the secondary transfer nip. After the sheet P separates from the secondary transfer belt 71, the conveyance belt 60 conveys the sheet P to the fixing device 50. The fixing device 50 includes a fixing belt and a pressure roller. The fixing belt and the pressure roller fix the color toner image transferred on a surface of the sheet P thereon under heat and pressure in a fixing process.

The image forming apparatus 100 further includes a second conveyance path K2, a third conveyance path K3, a fourth conveyance path K4, an output roller pair, a stacker, and a secondary transfer belt device 69. Thereafter, the output roller pair ejects the sheet P onto an outside of the image forming apparatus 100 through the second conveyance path K2. The sheet P ejected onto the outside of the image forming apparatus 100 by the output roller pair is stacked on the stacker successively as an output.

Thus, a series of image forming processes performed by the image forming apparatus 100 finishes.

As illustrated in FIG. 1, the image forming apparatus 100 according to the embodiment further includes a duplex unit 40. In order to transfer a toner image formed on the intermediate transfer belt 8 onto a back side of a sheet P transferred with a toner image on a front side of the sheet P at the secondary transfer nip (e.g., a transfer nip), the duplex unit 40 conveys the sheet P to the secondary transfer nip.

For example, in a case that the user selects a duplex printing mode for printing on both sides (e.g., the front side and the back side) of the sheet P, the sheet P fixed with the toner image on the front side of the sheet P in the fixing process is not ejected onto the stacker unlike a case that the user selects a single-sided printing mode as described above. The sheet P is guided to the third conveyance path K3 in the duplex unit 40. After the duplex unit 40 moves the sheet P backward to reverse the sheet P, the duplex unit 40 conveys the sheet P to the secondary transfer nip (e.g., the secondary transfer belt device 69) again through the fourth conveyance path K4. The secondary transfer roller 72 secondarily transfers a toner image onto the back side of the sheet P at the secondary transfer nip with image forming processes (e.g., image forming operations) similar to the image forming processes described above. Thereafter, the fixing device 50 fixes the toner image on the back side of the sheet P in the fixing process. The sheet P passes through the second conveyance path K2 and is ejected from the apparatus body of the image forming apparatus 100.

Referring to FIG. 2, a detailed description is provided of a construction and operations of the developing device 5Y (e.g., a developing portion) of the image forming device 6Y.

The developing device 5Y includes a developing roller 51Y, a doctor blade 52Y, two conveying screws 55Y, and a density sensor 56Y. The developing roller 51Y is disposed opposite the photoconductive drum 1Y. The doctor blade 52Y is disposed opposite the developing roller 51Y. The developing device 5Y further includes developer containers that accommodate the two conveying screws 55Y, respectively. The density sensor 56Y detects a toner density of toner contained in a developer. The developing roller 51Y includes a magnet that is secured inside the developing roller 51Y and a sleeve that rotates around the magnet. Each of the developer containers contains a two-component developer G made of carriers and toner.

The following describes the operations of the developing device 5Y having the construction described above.

The sleeve of the developing roller 51Y rotates in a direction indicated by arrow in FIG. 2. The magnet generates a magnetic field that moves the developer G borne on the developing roller 51Y thereon as the sleeve rotates. The developer G inside the developing device 5Y is adjusted such that a rate (e.g., the toner density) of the toner of the developer G is in a predetermined range. For example, the image forming apparatus 100 further includes a toner container 58. In a case that the density sensor 56Y disposed in the developing device 5Y detects a decreased toner density, the toner container 58 supplies fresh toner into the developing device 5Y to adjust the toner density to be in the predetermined range.

Thereafter, while the two conveying screws 55Y mix and agitate the fresh toner supplied into the developer containers from the toner container 58 with the developer G, the conveying screws 55Y circulate the fresh toner and the developer G in the two isolated developer containers in a moving direction perpendicular to the paper surface of FIG. 2. The toner of the developer G is adhered to the carrier by triboelectric charging with the carrier and borne on the developing roller 51Y with the carrier by a magnetic force generated on the developing roller 51Y.

The developing roller 51Y conveys the developer G borne thereon in the direction indicated by arrow in FIG. 2 to an opposed position where the developing roller 51Y is disposed opposite the doctor blade 52Y. The doctor blade 52Y adjusts an amount of the developer G on the developing roller 51Y to an appropriate amount at the opposed position. Thereafter, the developing roller 51Y conveys the developer G to an opposed position (e.g., a developing region) where the developing roller 51Y is disposed opposite the photoconductive drum 1Y. The toner of the developer G is attracted to an electrostatic latent image formed on the photoconductive drum 1Y by an electric field generated in the developing region. Thereafter, as the sleeve of the developing roller 51Y rotates, the developer G remaining on the developing roller 51Y reaches an upper portion of the developer container and separates from the developing roller 51Y.

The toner container 58 is removably installed in the developing device 5Y of the image forming apparatus 100 such that the toner container 58 is replaceable. When the toner container 58 for containing the fresh toner is empty, the user removes the toner container 58 from the developing device 5Y of the image forming apparatus 100 and replaces with a new one.

Referring to FIG. 3 and the like, a detailed description is provided of a construction of an intermediate transfer belt device 15 of the image forming apparatus 100 according to an embodiment of the present disclosure.

As illustrated in FIG. 3, the intermediate transfer belt device 15 includes the intermediate transfer belt 8, the four primary transfer rollers 9Y, 9M, 9C, and 9K, the driving roller 16, the driven roller 17, the pre-transfer roller 18, the tension roller 19, the cleaner opposed roller 20, the lubricant opposed roller 21, the backup roller 22, the intermediate transfer belt cleaner 10, the lubricant supply 30 serving as the intermediate transfer lubricant supply, and the secondary transfer opposed roller 23.

The intermediate transfer belt 8 contacts the four photoconductive drums 1Y, 1M, 1C, and 1K that bear the yellow, magenta, cyan, and black toner images, respectively, to form the primary transfer nips therebetween. The intermediate transfer belt 8 is stretched across and supported mainly by the eight rollers, that is, the driving roller 16, the driven roller 17, the pre-transfer roller 18, the tension roller 19, the cleaner opposed roller 20, the lubricant opposed roller 21, the backup roller 22, and the secondary transfer opposed roller 23.

The primary transfer rollers 9Y, 9M, 9C, and 9K are disposed opposite the photoconductive drums 1Y, 1M, 1C, and 1K, respectively, via the intermediate transfer belt 8. For example, the primary transfer roller 9Y that transfers the yellow toner image is disposed opposite the photoconductive drum 1Y that bears the yellow toner image via the intermediate transfer belt 8. The primary transfer roller 9M that transfers the magenta toner image is disposed opposite the photoconductive drum 1M that bears the magenta toner image via the intermediate transfer belt 8. The primary transfer roller 9C that transfers the cyan toner image is disposed opposite the photoconductive drum 1C that bears the cyan toner image via the intermediate transfer belt 8. The primary transfer roller 9K that transfers the black toner image is disposed opposite the photoconductive drum 1K that bears the black toner image via the intermediate transfer belt 8.

The driving roller 16 is disposed downstream from the four photoconductive drums 1Y, 1M, 1C, and 1K in the rotation direction D8 of the intermediate transfer belt 8. The driving roller 16 contacts an inner circumferential face of the intermediate transfer belt 8 in a state in which the intermediate transfer belt 8 is wrapped around the driving roller 16 at a wrap angle of approximately 120 degrees. The image forming apparatus 100 further includes a controller and a motor Mt1. The controller controls the motor Mt1 to drive and rotate the driving roller 16 clockwise in FIG. 3. Accordingly, the driving roller 16 rotates the intermediate transfer belt 8 clockwise in FIG. 3 in the predetermined rotation direction D8.

As the intermediate transfer belt 8 rotates, the intermediate transfer belt 8 drives and rotates the driven roller 17, the pre-transfer roller 18, the tension roller 19, the cleaner opposed roller 20, the lubricant opposed roller 21, the backup roller 22, and the secondary transfer opposed roller 23, that are other than the driving roller 16.

Referring to FIGS. 4A, 4B, 5, 6, 7, and 8 and the like, a detailed description is provided of a construction of the driver 90 installed in the image forming apparatus 100 according to an embodiment of the present disclosure.

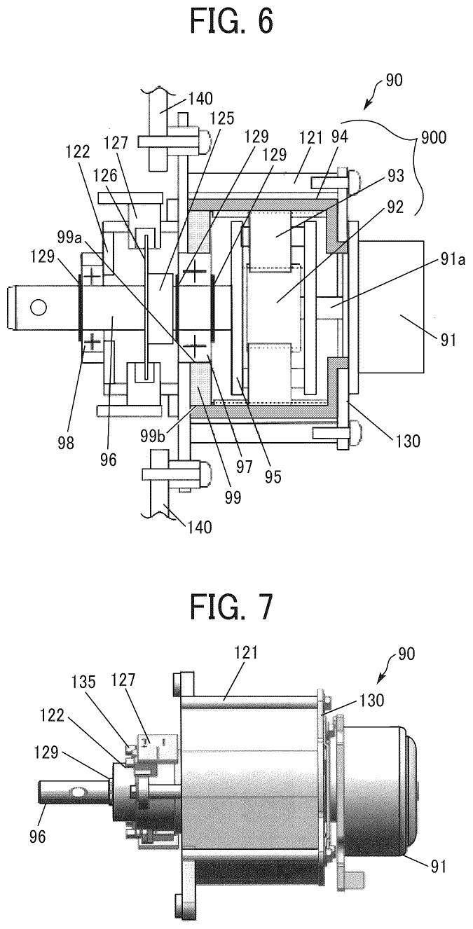

According to the embodiment, the driver 90 depicted in FIG. 6 and the like drives and rotates a photoconductive drum 1 serving as a driven body.

Referring to FIG. 4A and the like, a description is provided of a construction of the photoconductive drum 1 that represents each of the four photoconductive drums 1Y, 1M, 1C, and 1K and omits alphabetical letters (e.g., Y, M, C, and K) of reference numerals properly.

As illustrated in FIGS. 4A and 4B, the photoconductive drum 1 is removably installed in the apparatus body of the image forming apparatus 100.

As illustrated in FIG. 4A, the photoconductive drum 1 is tubular. The photoconductive drum 1 accommodates a bearing 1a and an internal gear 1b. As the photoconductive drum 1 moves in an axial direction as an attachment direction A1 indicated by white arrow in FIG. 4A, the bearing 1a engages a drum shaft 110 disposed in the apparatus body of the image forming apparatus 100. Thus, the photoconductive drum 1 is installed in the apparatus body of the image forming apparatus 100. The internal gear 1b meshes with a driving gear 111 mounted on the drum shaft 110.

On the other hand, the image forming apparatus 100 further includes a rear plate 115 and a ball bearing 116. The rear plate 115 rotatably supports the drum shaft 110 through the ball bearing 116. The rear plate 115 is disposed opposite a downstream portion of the drum shaft 110 in the attachment direction A1, that is, a right portion of the drum shaft 110 in FIG. 4B, and a rear of the apparatus body of the image forming apparatus 100. The image forming apparatus 100 further includes a panel that rotatably supports an upstream portion of the drum shaft 110 in the attachment direction A1 through a ball bearing. The upstream portion of the drum shaft 110 is a left portion of the drum shaft 110 in FIG. 4B and disposed opposite a front of the apparatus body of the image forming apparatus 100. The upstream portion of the drum shaft 110 is mounted on the panel after the photoconductive drum 1 is installed in the apparatus body of the image forming apparatus 100.

The driver 90 depicted in FIG. 6 and the like is disposed on a rear side of the image forming apparatus 100 with respect to the rear plate 115, that is, on the right of the rear plate 115 in FIG. 4B. For example, the driver 90 includes a mount 140 depicted in FIG. 6 that is fastened to the rear plate 115 with a screw. Thus, the mount 140 is secured to and stationarily supported by the rear plate 115.

As illustrated in FIG. 5, according to the embodiment, the image forming apparatus 100 further includes a joint 160 that couples an output shaft 96 of the driver 90 depicted in FIG. 6 with the drum shaft 110. According to the embodiment, the image forming apparatus 100 further includes a screw 161 that fastens the output shaft 96 to the joint 160. The joint 160 rotates together with the drum shaft 110.

A coupling method for coupling the drum shaft 110 with the output shaft 96 is not limited to the embodiment described above and may employ other embodiments.

As illustrated in FIGS. 6 to 8 and the like, the driver 90 according to the embodiment includes a planetary gear reducer serving as a gear reducer, a reduction mechanism, or a decelerator. The driver 90 further includes a driving motor 91 serving as a driving source. The driver 90 decreases a number of rotations of the driving motor 91 to drive and rotate the photoconductive drum 1. As described above, according to the embodiment, the driver 90 that drives the photoconductive drum 1 employs the planetary gear reducer serving as the gear reducer, the reduction mechanism, or the decelerator, reducing a rotational speed of the photoconductive drum 1 with improved efficiency.

As illustrated in FIG. 6, the driver 90 further includes the driving motor 91 serving as the driving source, a sun gear 92, planetary gears 93, an internal gear 94 (e.g., an internal toothed gear), a carrier 95 serving as a support, the output shaft 96, a first bearing 97, a second bearing 98, an internal gear holder 99 serving as a first holder, a housing 121 serving as a second holder, a sensor holder 122 serving as a third holder, and an encoder assembly including an encoder sensor 127.

The driver 90 further includes a motor mounting plate 130 serving as a mounting plate. The housing 121 serving as the second holder supports the driving motor 91 serving as the driving source through the motor mounting plate 130.

The driving motor 91 includes a motor shaft 91a that mounts the sun gear 92. The driving motor 91 serving as the driving source drives and rotates the sun gear 92 directly.

The planetary gears 93 mesh with the sun gear 92. According to the embodiment, the plurality of planetary gears 93 (e.g., four planetary gears 93 according to the embodiment) is arranged in a circumferential direction of the sun gear 92 with an even gap between the adjacent planetary gears 93 and meshes with the single sun gear 92.

The internal gear 94 includes internal teeth disposed on an inner circumferential face of the internal gear 94 and meshes with the planetary gears 93.

The carrier 95 rotatably supports the planetary gears 93. The carrier 95 is combined with the output shaft 96 that has a central axis that is coaxially aligned with a central axis of each of the sun gear 92 and the internal gear 94. As described above with reference to FIGS. 4 and 5, the output shaft 96 transmits a driving force to the drum shaft 110 mounting the photoconductive drum 1. The carrier 95 and the output shaft 96 may be made of a shared material or different materials, respectively, by press-fitting or the like, thus being combined with each other.

The first bearing 97 rotatably supports the output shaft 96. According to the embodiment, the first bearing 97 is a ball bearing. In other words, the first bearing 97 supports the output shaft 96 coaxially with the internal gear 94.

The internal gear holder 99 has a substantially toroidal shape. The internal gear holder 99 serves as the first holder that has an inner circumferential portion 99a that non-rotatably supports the first bearing 97 and an outer circumferential portion 99b that non-rotatably supports the internal gear 94. In other words, the internal gear holder 99 supports the first bearing 97 coaxially with the internal gear 94. According to the embodiment, the internal gear 94 includes a toothless portion that does not have internal teeth and is disposed at a left end of the internal gear 94 in FIG. 6. The toothless portion of the internal gear 94 is press-fitted into the outer circumferential portion 99b of the internal gear holder 99.

The housing 121 serves as the second holder that non-rotatably supports the driving motor 91 serving as the driving source and the first bearing 97. According to the embodiment, the driving motor 91 is fastened to the housing 121 with a screw through the motor mounting plate 130, thus being secured to and stationarily supported by the housing 121. Conversely, the housing 121 includes a fitting hole into which the first bearing 97 is fitted. Thus, the first bearing 97 is secured to and stationarily supported by the housing 121. The driver 90 further includes retaining rings 129 that position the first bearing 97 in an axial direction of the output shaft 96.

According to the embodiment, the housing 121 that holds a main portion of the driver 90 is fastened to the mount 140 with a screw, thus being secured to and stationarily supported by the mount 140. The mount 140 that holds the housing 121 of the driver 90 is fastened to the rear plate 115 depicted in FIG. 4B with a screw. Thus, the mount 140 is secured to and stationarily supported by the rear plate 115.

The second bearing 98 rotatably supports the output shaft 96. According to the embodiment, the second bearing 98 is a ball bearing. The second bearing 98 is separated from the driving motor 91 serving as the driving source farther than the first bearing 97 is. The second bearing 98 is disposed on the left of the first bearing 97 in FIG. 6.

The sensor holder 122 serves as the third holder that is secured to and stationarily supported by the housing 121 serving as the second holder. The sensor holder 122 also serves as a mounting plate (e.g., a holding plate) that supports the encoder sensor 127.

According to the embodiment, the housing 121 serving as the second holder supports the second bearing 98 indirectly through the sensor holder 122 serving as the third holder. According to the embodiment, the sensor holder 122 includes a bearing fitting portion disposed at a left end of the sensor holder 122 in FIG. 6. The second bearing 98 is fitted into the bearing fitting portion of the sensor holder 122. The retaining ring 129 prevents the second bearing 98 from falling out from the sensor holder 122. The sensor holder 122 is positioned with respect to the housing 121 with improved accuracy. The sensor holder 122 serves as a component combined with the housing 121.

As described above, the driver 90 according to the embodiment includes the second bearing 98 that is supported by the housing 121 serving as the second holder indirectly. Hence, the two bearings, that is, the first bearing 97 and the second bearing 98, supported by the housing 121 rotatably support the output shaft 96. Accordingly, compared to a configuration in which a single bearing supports the output shaft 96, a configuration in which a bearing supported by the housing 121 and a bearing supported by a component mounted on the housing 121 with a decreased accuracy support the output shaft 96, and the like, the driver 90 suppresses tilting of the output shaft 96 that transmits a driving force to the photoconductive drum 1 serving as the driven body. Hence, the driver 90 also suppresses a failure that the output shaft 96 tilts and the photoconductive drum 1 vibrates and a failure that the photoconductive drum 1 rotates unevenly.

A description is provided of a construction of a comparative driver.

The comparative driver employs a planetary gear reducer that causes a driving motor to reduce a rotational speed of a photoconductive drum with improved efficiency.

The comparative driver employing the planetary gear reducer reduces the rotational speed of the photoconductive drum with improved efficiency. However, an output shaft that transmits a driving force to a driven body such as the photoconductive drum may tilt, causing vibration and uneven rotation of the driven body.

A supplementary description is provided of advantages of the driver 90 according to the embodiment described above.

Even if a bearing is a ball bearing, the bearing has backlash inside. Hence, with a housing that supports an outer circumferential portion (e.g., an outer race) of the bearing, the output shaft 96 may tilt. If the output shaft 96 tilts, the carrier 95 that supports the planetary gears 93 performing final gear meshing for reduction may also tilt. The planetary gear reducer may generate alignment error, increasing gear meshing vibration and causing vibration and uneven rotation of the photoconductive drum 1. For example, the driver 90 according to the embodiment drives and rotates the photoconductive drum 1 serving as the driven body. Hence, if the vibration and the uneven rotation of the photoconductive drum 1 generate, a toner image formed on a sheet P may suffer from fine-pitch image unevenness (e.g., banding).

To address the circumstance, the driver 90 according to the embodiment includes the two bearings, that is, the first bearing 97 and the second bearing 98, that support the output shaft 96, minimizing tilting of the output shaft 96 and improving accuracy in positioning the planetary gears 93 with respect to the internal gear 94. Thus, the driver 90 decreases tilting of the carrier 95 supporting the planetary gears 93 performing final gear meshing of the planetary gear reducer. Accordingly, the driver 90 decreases gear meshing vibration of the planetary gear reducer, also reducing fine-pitch image unevenness (e.g., banding) on the toner image formed on the sheet P, that is caused by vibration and uneven rotation of the photoconductive drum 1.

According to the embodiment, the housing 121 serving as the second holder that supports the first bearing 97 supports the second bearing 98 indirectly through the sensor holder 122 serving as the third holder. Alternatively, the housing 121 serving as the second holder that supports the first bearing 97 may support the second bearing 98 directly.

The driver 90 that achieves the advantages described above has an advantageous construction described below.

For example, the driver 90 according to the embodiment includes the driving motor 91 and the motor mounting plate 130 serving as the mounting plate that mounts the driving motor 91 stationarily. The driver 90 further includes the output shaft 96 having a center of rotation disposed on a substantially identical, hypothetical straight line shared with a center of rotation of the motor shaft 91a of the driving motor 91. The driver 90 further includes a planetary gear reducer 900 serving as a gear reducer, a reduction mechanism, or a decelerator including the sun gear 92, the planetary gears 93, and the internal gear 94. The planetary gear reducer 900 decreases a rotational speed of the driving motor 91 and transmits a driving force generated by the driving motor 91 to the output shaft 96. The driver 90 further includes the first bearing 97, the internal gear holder 99, and the housing 121. The first bearing 97 rotatably supports the output shaft 96. The internal gear holder 99 serves as the first holder that has the inner circumferential portion 99a that non-rotatably supports the first bearing 97 and the outer circumferential portion 99b that non-rotatably supports the planetary gear reducer 900 including the sun gear 92, the planetary gears 93, and the internal gear 94. The housing 121 serves as the second holder that non-rotatably supports the motor mounting plate 130 serving as the mounting plate and the first bearing 97. The second bearing 98 is separated from the driving motor 91 farther than the first bearing 97 is. The second bearing 98 rotatably supports the output shaft 96. The housing 121 serving as the second holder supports the second bearing 98 directly or indirectly.

As illustrated in FIGS. 6 to 8, the driver 90 according to the embodiment includes the encoder assembly to rotate the output shaft 96 coupled with the photoconductive drum 1 stably. The encoder assembly includes an encoder wheel 126, a wheel holder 125, and the encoder sensor 127.

As illustrated in FIG. 6, the encoder wheel 126 is interposed between the first bearing 97 and the second bearing 98. The encoder wheel 126 is combined with the output shaft 96 and substantially disk-shaped. The encoder wheel 126 includes a plurality of patterns arranged on an outer circumferential portion on a surface of the encoder wheel 126 with an even gap between adjacent patterns in a circumferential direction of the encoder wheel 126. The patterns include a pattern that has an optical reflectance different from an optical reflectance of other portion and an opening. According to the embodiment, the encoder wheel 126 is mounted on the output shaft 96 through the wheel holder 125, thus being secured to and stationarily supported by the output shaft 96.

The encoder sensor 127 is a photodetector that detects the patterns of the encoder wheel 126. The encoder sensor 127 is secured to and stationarily supported by the sensor holder 122 serving as the third holder directly or indirectly. The encoder sensor 127 optically detects the patterns of the encoder wheel 126 that rotates with the output shaft 96. Thus, the encoder sensor 127 detects the number of rotations and uneven rotation of the output shaft 96. The controller performs feedback control for the driving motor 91 based on detection data provided by the encoder sensor 127. Thus, the driving motor 91 drives and rotates the output shaft 96 coupled with the photoconductive drum 1 stably with a target number of rotations without uneven rotation.

According to the embodiment, as described above, the encoder wheel 126 is mounted on the output shaft 96 supported by the two bearings, that is, the first bearing 97 and the second bearing 98, that prevent the output shaft 96 from tilting. The sensor holder 122 is positioned with respect to the housing 121 supporting the two bearings, that is, the first bearing 97 and the second bearing 98, directly or indirectly with improved accuracy. The sensor holder 122 supports the encoder sensor 127. Accordingly, the encoder wheel 126 is positioned with respect to the output shaft 96 with improved accuracy. Additionally, the encoder sensor 127 is positioned with respect to the encoder wheel 126 with improved accuracy. Hence, the encoder assembly constructed of the wheel holder 125, the encoder wheel 126, and the encoder sensor 127 also improves detection accuracy.

As illustrated in FIG. 7, the driver 90 according to the embodiment further includes a rivet 135. The encoder sensor 127 is secured to and stationarily supported by the sensor holder 122 with the rivet 135. The sensor holder 122 is fastened to the housing 121 with a screw, thus being secured to and stationarily supported by the housing 121.

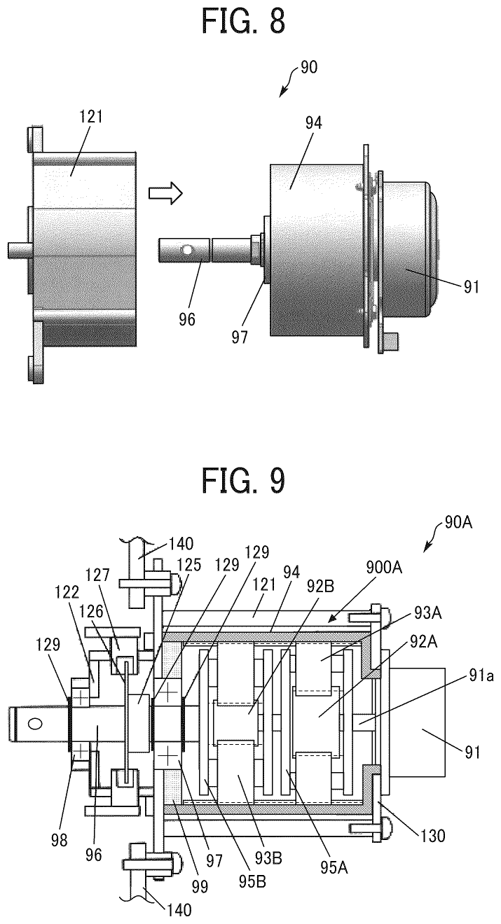

As illustrated in FIGS. 6 and 8, the housing 121 serving as the second holder covers the internal gear 94. For example, the housing 121 covers the internal gear 94 with a clearance between the housing 121 and an outer circumferential portion of the internal gear 94. The housing 121 is positioned at an outer circumferential portion (e.g., an outer race) of the first bearing 97. Accordingly, the housing 121 covering the internal gear 94 prevents noise generated by the planetary gear reducer 900 of the driver 90 from leaking out of the housing 121.

In the driver 90 according to the embodiment, a coefficient of thermal expansion of the internal gear holder 99 serving as the first holder is equivalent to a coefficient of thermal expansion of the internal gear 94.

For example, according to the embodiment, the internal gear holder 99 and the internal gear 94 are made of an identical material.

Accordingly, even if the driver 90 is used for an extended period of time and the planetary gear reducer 900 inside the driver 90 suffers from temperature increase, the internal gear holder 99 and the internal gear 94 prevent a gap from generating between an outer diameter portion of the internal gear holder 99 and an inner diameter portion of the internal gear 94. Thus, the internal gear 94 and the internal gear holder 99 attain a stable positional relation therebetween, retaining stable driving of the driver 90.

In the driver 90 according to the embodiment, a coefficient of thermal expansion of the housing 121 serving as the second holder is equivalent to a coefficient of thermal expansion of the sensor holder 122 serving as the third holder.

For example, according to the embodiment, the housing 121 and the sensor holder 122 are made of an identical material.

Accordingly, even if the driver 90 is used for an extended period of time and the housing 121 and the sensor holder 122 suffer from temperature increase, the first bearing 97 supported by the housing 121 and the second bearing 98 supported by the sensor holder 122 attain a stable positional relation, reducing tilting of the output shaft 96 constantly.

In the driver 90 according to the embodiment, a rigidity of the housing 121 serving as the second holder is greater than a rigidity of the internal gear holder 99 serving as the first holder.

For example, according to the embodiment, a rigidity of a material of the housing 121 is greater than a rigidity of a material of the internal gear holder 99.

Accordingly, the housing 121 secures the driver 90 to the rear plate 115 of the apparatus body of the image forming apparatus 100 rigidly. Hence, even if the photoconductive drum 1 is installed into and removed from the apparatus body of the image forming apparatus 100 repeatedly, the housing 121 retains rigid securing of the driver 90 with respect to the apparatus body of the image forming apparatus 100.

A description is provided of a construction of a driver 90A as a first modification example of the driver 90.

As illustrated in FIG. 9, the driver 90A as the first modification example is different from the driver 90 depicted in FIG. 6 in a construction that the driver 90A includes two sets of a sun gear, planetary gears, and a carrier, that is, a first set of a first sun gear 92A, first planetary gears 93A, and a first carrier 95A and a second set of a second sun gear 92B, second planetary gears 93B, and a second carrier 95B. Each of the first carrier 95A and the second carrier 95B serves as a support.

As illustrated in FIG. 9, in the driver 90A as the first modification example, the first planetary gears 93A mesh with the first sun gear 92A mounted on the motor shaft 91a of the driving motor 91. The plurality of first planetary gears 93A is arranged in a circumferential direction of the first sun gear 92A. The first carrier 95A rotatably supports the first planetary gears 93A. The first carrier 95A is coupled with the second carrier 95B combined with the output shaft 96 and disposed at an output side of the driver 90A. Thus, the first carrier 95A is combined with the output shaft 96 indirectly.

The second carrier 95B rotatably supports the second sun gear 92B at a central axis of the second carrier 95B. The second sun gear 92B meshes with the plurality of second planetary gears 93B arranged in a circumferential direction of the second sun gear 92B, thus rotatably supporting the second planetary gears 93B.

The second planetary gears 93B are spaced apart from the first planetary gears 93A in the axial direction of the output shaft 96. The first planetary gears 93A and the second planetary gears 93B mesh with the internal gear 94. Accordingly, the driving motor 91 serving as the driving source also drives and rotates the second sun gear 92B indirectly.

The driver 90A includes other components that are equivalent to the components of the driver 90 depicted in FIG. 6. Hence, a description of constructions and operations of the components is omitted.

With the driver 90A having the construction described above also, the two bearings, that is, the first bearing 97 and the second bearing 98, supported by the housing 121 and the sensor holder 122 combined with and supported by the housing 121 rotatably support the output shaft 96. Hence, the driver 90A suppresses tilting of the output shaft 96 that transmits a driving force to the photoconductive drum 1.

Additionally, the driver 90A as the first modification example incorporates the two sets of the sun gear, the planetary gears, and the carrier, that is, the first set of the first sun gear 92A, the first planetary gears 93A, and the first carrier 95A and the second set of the second sun gear 92B, the second planetary gears 93B, and the second carrier 95B. Hence, compared to a driver incorporating a single set of the sun gear, the planetary gears, and the carrier, the driver 90A improves a reduction rate of a planetary gear reducer 900A without upsizing the driver 90A. The planetary gear reducer 900A serves as a gear reducer, a reduction mechanism, or a decelerator including the first sun gear 92A, the second sun gear 92B, the first planetary gears 93A, the second planetary gears 93B, and the internal gear 94.

The driver 90A depicted in FIG. 9 incorporates the two sets of the sun gear, the planetary gears, and the carrier, that is, the first set of the first sun gear 92A, the first planetary gears 93A, and the first carrier 95A and the second set of the second sun gear 92B, the second planetary gears 93B, and the second carrier 95B. Alternatively, the driver 90A may incorporate three or more sets of the sun gear, the planetary gears, and the carrier.

A description is provided of a construction of a driver 90B as a second modification example of the driver 90.

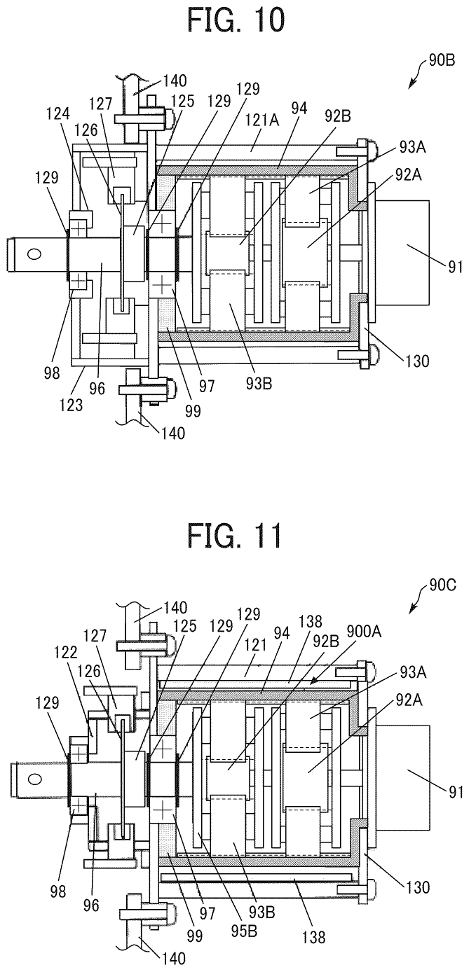

As illustrated in FIG. 10, the driver 90B as the second modification example is different from the driver 90A depicted in FIG. 9 in a construction that the driver 90B includes an encoder cover 123 instead of the sensor holder 122, as a third holder.

As illustrated in FIG. 10, like the driver 90A depicted in FIG. 9, the driver 90B as the second modification example also incorporates the encoder wheel 126 that is interposed between the first bearing 97 and the second bearing 98. The encoder wheel 126 is combined with the output shaft 96.

Unlike the driver 90A depicted in FIG. 9, the driver 90B as the second modification example incorporates a housing 121A serving as a second holder that supports the encoder sensor 127 that detects the patterns of the encoder wheel 126. The housing 121A may support the encoder sensor 127 directly. The housing 121A may support the encoder sensor 127 indirectly through a mounting plate or the like.

In the driver 90B as the second modification example, the encoder cover 123 is fastened to the housing 121A serving as the second holder with a screw or the like, thus being supported by the housing 121A. The driver 90B includes a bearing fitting portion 124. The encoder cover 123 serves as the third holder that causes the bearing fitting portion 124 to fit and support the second bearing 98.

The encoder cover 123 serving as the third holder covers the encoder wheel 126 and the encoder sensor 127. The encoder cover 123 prevents noise generated inside the encoder cover 123 from leaking out of the encoder cover 123.

With the driver 90B having the construction described above also, the two bearings, that is, the first bearing 97 and the second bearing 98, supported by the housing 121A and the encoder cover 123 combined with and supported by the housing 121A rotatably support the output shaft 96. Hence, the driver 90B suppresses tilting of the output shaft 96 that transmits a driving force to the photoconductive drum 1.

A description is provided of a construction of a driver 90C as a third modification example of the driver 90.

As illustrated in FIG. 11, the driver 90C as the third modification example is different from the driver 90A depicted in FIG. 9 in a construction that the driver 90C includes a noise absorber 138 that is interposed between the housing 121 serving as the second holder and the internal gear 94.

As illustrated in FIG. 11, the driver 90C as the third modification example includes the noise absorber 138 that is adhered to an inner circumferential face of the housing 121 such that the noise absorber 138 covers the outer circumferential portion of the internal gear 94 circumferentially. The noise absorber 138 attenuates vibration that travels through the air. The noise absorber 138 may employ general noise absorbers.

As described above, the noise absorber 138 is interposed between the housing 121 and the internal gear 94. The noise absorber 138 reduces noise that generates from the planetary gear reducer 900A as a major noise source and leaks out of the driver 90C.

With the driver 90C having the construction described above also, the two bearings, that is, the first bearing 97 and the second bearing 98, supported by the housing 121 and the sensor holder 122 combined with and supported by the housing 121 rotatably support the output shaft 96. Hence, the driver 90C suppresses tilting of the output shaft 96 that transmits a driving force to the photoconductive drum 1.

A description is provided of a construction of a driver 90D as a fourth modification example of the driver 90.

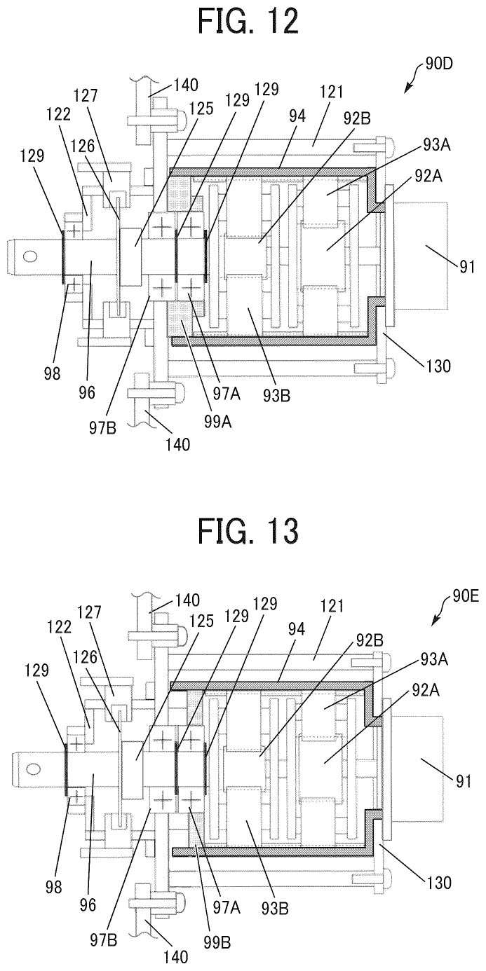

As illustrated in FIG. 12, the driver 90D as the fourth modification example is different from the driver 90A depicted in FIG. 9 in a construction that the driver 90D includes two bearings, that is, first bearings 97A and 97B, that are disposed adjacent to each other in the axial direction of the output shaft 96.

As illustrated in FIG. 12, in the driver 90D as the fourth modification example, the two bearings, that is, the first bearings 97A and 97B, rotatably support the output shaft 96. The driver 90D includes an internal gear holder 99A serving as a first holder that supports the first bearing 97A disposed at a driving side (e.g., a right side in FIG. 12) of the driver 90D. Conversely, the internal gear holder 99A serving as the first holder and the housing 121 serving as the second holder support the first bearing 97B disposed at an output side (e.g., a left side in FIG. 12) of the driver 90D. In this case, the internal gear holder 99A and the housing 121 support the two bearings, that is, the first bearings 97A and 97B, as a pair of first bearings.

The housing 121 supports the second bearing 98 through the sensor holder 122 serving as the third holder.

Thus, the three bearings, that is, the first bearings 97A and 97B and the second bearing 98, supported by the housing 121 and the sensor holder 122 combined with and supported by the housing 121 rotatably support the output shaft 96. Hence, the driver 90D further suppresses tilting of the output shaft 96 that transmits a driving force to the photoconductive drum 1.

FIG. 13 illustrates a driver 90E that includes the two bearings, that is, the first bearings 97A and 97B, that are disposed adjacent to each other in the axial direction of the output shaft 96. The driver 90E further includes an internal gear holder 99B. The internal gear holder 99B serving as a first holder and the housing 121 serving as the second holder support the first bearing 97A disposed at a driving side of the driver 90E. The housing 121 serving as the second holder supports the first bearing 97B disposed at an output side of the driver 90E. In this case also, the internal gear holder 99B and the housing 121 support the two bearings, that is, the first bearings 97A and 97B, as the pair of first bearings. Hence, the driver 90E further suppresses tilting of the output shaft 96.

A description is provided of a construction of a driver 90F as a fifth modification example of the driver 90.

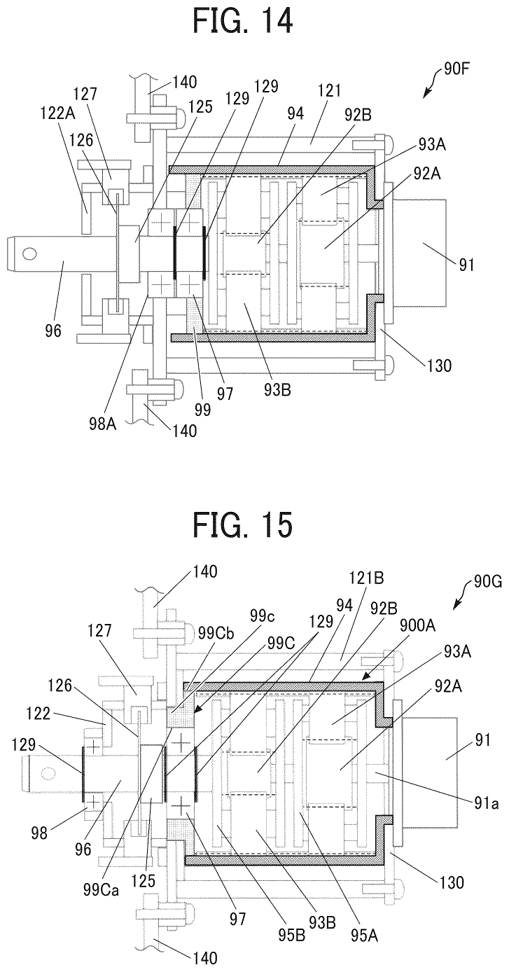

As illustrated in FIG. 14, the driver 90F as the fifth modification example is different from the driver 90D depicted in FIG. 12 in a construction that the driver 90F includes a second bearing 98A that is not supported by the housing 121 through the sensor holder 122 serving as the third holder.

As illustrated in FIG. 14, the driver 90F as the fifth modification example incorporates the two bearings, that is, the first bearing 97 and the second bearing 98A, that are disposed adjacent to each other in the axial direction of the output shaft 96. The internal gear holder 99 serving as the first holder and the housing 121 serving as the second holder support the first bearing 97 disposed at a driving side of the driver 90F. The housing 121 serving as the second holder supports the second bearing 98A disposed at an output side of the driver 90F directly.

With the driver 90F having the construction described above also, the two bearings, that is, the first bearing 97 and the second bearing 98A, supported by the housing 121 rotatably support the output shaft 96. Hence, the driver 90F suppresses tilting of the output shaft 96 that transmits a driving force to the photoconductive drum 1.

With the above-described construction of the driver 90F, the encoder wheel 126 combined with the output shaft 96 is disposed closer to the output side than the second bearing 98A is. The driver 90F further includes a sensor holder 122A. The housing 121 serving as the second holder supports the encoder sensor 127 indirectly through the sensor holder 122A. However, the encoder wheel 126 is mounted on the output shaft 96 that does not tilt easily. Hence, the encoder assembly constructed of the wheel holder 125, the encoder wheel 126, and the encoder sensor 127 retains improved performance.

In the driver 90F as the fifth modification example, the second bearing 98A does not abut on an output side end of the sensor holder 122A. Hence, a gap may be formed between the output side end of the sensor holder 122A and the output shaft 96. Accordingly, in order to prevent a foreign substance from entering through the gap, the gap is preferably minimized or sealed with a seal or the like.

A description is provided of a construction of a driver 90G as a sixth modification example of the driver 90.

As illustrated in FIG. 15, the driver 90G as the sixth modification example is different from the driver 90A depicted in FIG. 9 in a construction that the driver 90G includes a housing 121B and an internal gear holder 99C. The housing 121B serving as a second holder non-rotatably supports the motor mounting plate 130 serving as the mounting plate and the internal gear holder 99C serving as a first holder. Conversely, the driver 90A depicted in FIG. 9 includes the housing 121 that non-rotatably supports the motor mounting plate 130 and the first bearing 97.

As illustrated in FIG. 15, unlike the internal gear holder 99 depicted in FIG. 9, the internal gear holder 99C serving as the first holder of the driver 90G as the sixth modification example includes a supported portion 99c that projects leftward in FIG. 15. As the supported portion 99c is press-fitted into an opening disposed at an end face of the housing 121B, the housing 121B non-rotatably supports and positions the internal gear holder 99C.

As illustrated in FIG. 9, the first bearing 97 positions the internal gear holder 99. Component accuracy of the internal gear holder 99 may generate cumulative tolerance between the second bearing 98 and the first bearing 97, degrading component accuracy such as coaxiality. To address the circumstance, the driver 90G as the sixth modification example incorporates the housing 121B that positions the internal gear holder 99C. Hence, the two bearings, that is, the first bearing 97 and the second bearing 98, rotatably support the output shaft 96 without degrading component accuracy. Thus, the driver 90G suppresses tilting of the output shaft 96 that transmits a driving force to the photoconductive drum 1.

The driver 90G that achieves the advantages described above has an advantageous construction described below.

For example, the driver 90G according to the embodiment includes the driving motor 91 and the motor mounting plate 130 serving as the mounting plate that mounts the driving motor 91 stationarily. The driver 90G further includes the output shaft 96 having the center of rotation disposed on the substantially identical, hypothetical straight line shared with the center of rotation of the motor shaft 91a of the driving motor 91. The driver 90G further includes the planetary gear reducer 900A serving as the gear reducer, the reduction mechanism, or the decelerator including the first sun gear 92A, the second sun gear 92B, the first planetary gears 93A, the second planetary gears 93B, and the internal gear 94. The planetary gear reducer 900A decreases the rotational speed of the driving motor 91 and transmits a driving force generated by the driving motor 91 to the output shaft 96. The driver 90G further includes the first bearing 97, the internal gear holder 99C, and the housing 121B. The first bearing 97 rotatably supports the output shaft 96. The internal gear holder 99C serves as the first holder that has an inner circumferential portion 99Ca that non-rotatably supports the first bearing 97 and an outer circumferential portion 99Cb that non-rotatably supports the planetary gear reducer 900A including the first sun gear 92A, the second sun gear 92B, the first planetary gears 93A, the second planetary gears 93B, and the internal gear 94. The housing 121B serving as the second holder non-rotatably supports the motor mounting plate 130 serving as the mounting plate and the internal gear holder 99C serving as the first holder. The second bearing 98 is separated from the driving motor 91 farther than the first bearing 97 is. The second bearing 98 rotatably supports the output shaft 96. The housing 121B serving as the second holder supports the second bearing 98 directly or indirectly.

A description is provided of a construction of a driver 90H as a seventh modification example of the driver 90.

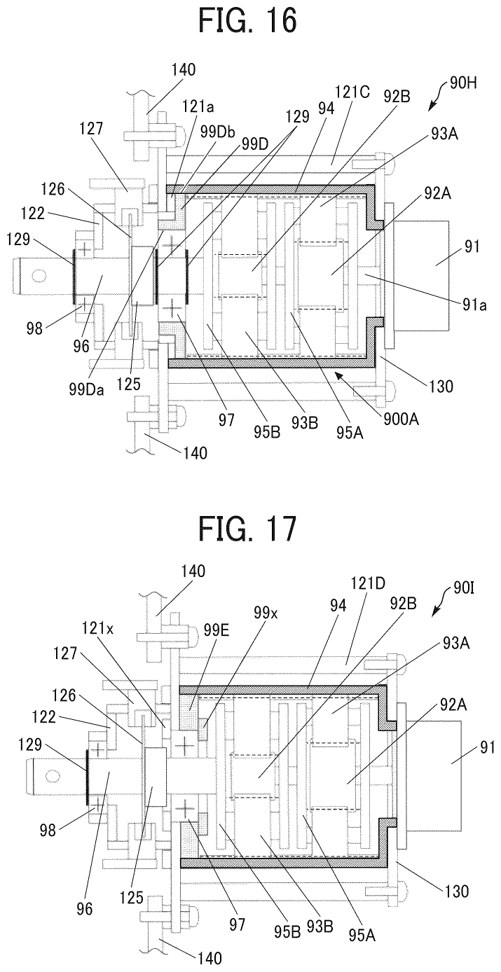

As illustrated in FIG. 16, the driver 90H as the seventh modification example is different from the driver 90A depicted in FIG. 9 and the driver 90G depicted in FIG. 15 in a construction that the driver 90H includes a housing 121C and an internal gear holder 99D. The housing 121C serving as a second holder non-rotatably supports the motor mounting plate 130 serving as the mounting plate and the internal gear 94 of the planetary gear reducer 900A serving as the gear reducer, the reduction mechanism, or the decelerator. Conversely, the driver 90A depicted in FIG. 9 includes the housing 121 that non-rotatably supports the motor mounting plate 130 and the first bearing 97. The driver 90G depicted in FIG. 15 includes the housing 121B that non-rotatably supports the motor mounting plate 130 serving as the mounting plate and the internal gear holder 99C serving as the first holder.

As illustrated in FIG. 16, unlike the housing 121 of the driver 90A depicted in FIG. 9, the housing 121C of the driver 90H as the seventh modification example includes a support portion 121a that is disposed on an inner wall of an end face of the housing 121C and projects rightward in FIG. 16. The internal gear 94 includes a toothless portion that does not have internal teeth and is disposed on the inner circumferential face of the internal gear 94. As the toothless portion of the internal gear 94 is press-fitted into the support portion 121a, the housing 121C non-rotatably supports and positions the internal gear 94.

In the driver 90A depicted in FIG. 9, the first bearing 97 positions the internal gear holder 99. Component accuracy of the internal gear holder 99 may generate cumulative tolerance between the second bearing 98 and the first bearing 97, degrading component accuracy such as coaxiality. To address the circumstance, the driver 90H as the seventh modification example incorporates the housing 121C that positions the internal gear 94 of the planetary gear reducer 900A serving as the gear reducer, the reduction mechanism, or the decelerator including the first sun gear 92A, the second sun gear 92B, the first planetary gears 93A, the second planetary gears 93B, and the internal gear 94. Hence, the two bearings, that is, the first bearing 97 and the second bearing 98, rotatably support the output shaft 96 without degrading component accuracy. Thus, the driver 90H suppresses tilting of the output shaft 96 that transmits a driving force to the photoconductive drum 1.

The driver 90H that achieves the advantages described above has an advantageous construction described below.

For example, the driver 90H according to the embodiment includes the driving motor 91 and the motor mounting plate 130 serving as the mounting plate that mounts the driving motor 91 stationarily. The driver 90H further includes the output shaft 96 having the center of rotation disposed on the substantially identical, hypothetical straight line shared with the center of rotation of the motor shaft 91a of the driving motor 91. The driver 90H further includes the planetary gear reducer 900A serving as the gear reducer, the reduction mechanism, or the decelerator including the first sun gear 92A, the second sun gear 92B, the first planetary gears 93A, the second planetary gears 93B, and the internal gear 94. The planetary gear reducer 900A decreases the rotational speed of the driving motor 91 and transmits a driving force generated by the driving motor 91 to the output shaft 96. The driver 90H further includes the first bearing 97, the internal gear holder 99D, and the housing 121C. The first bearing 97 rotatably supports the output shaft 96. The internal gear holder 99D serves as a first holder that has an inner circumferential portion 99Da that non-rotatably supports the first bearing 97 and an outer circumferential portion 99Db that non-rotatably supports the planetary gear reducer 900A including the first sun gear 92A, the second sun gear 92B, the first planetary gears 93A, the second planetary gears 93B, and the internal gear 94. The housing 121C serves as the second holder that non-rotatably supports the motor mounting plate 130 serving as the mounting plate and the planetary gear reducer 900A including the first sun gear 92A, the second sun gear 92B, the first planetary gears 93A, the second planetary gears 93B, and the internal gear 94. The second bearing 98 is separated from the driving motor 91 farther than the first bearing 97 is. The second bearing 98 rotatably supports the output shaft 96. The housing 121C serving as the second holder supports the second bearing 98 directly or indirectly.

A description is provided of a construction of a driver 90I as an eighth modification example of the driver 90.

As illustrated in FIG. 17, the driver 90I as the eighth modification example is different from the driver 90A depicted in FIG. 9 in a construction that the driver 90I includes an internal gear holder 99E serving as a first holder and a housing 121D serving as a second holder that restrict movement of the first bearing 97 in a thrust direction thereof. Conversely, the driver 90A depicted in FIG. 9 includes the retaining rings 129 that restrict movement of the first bearing 97 in the thrust direction thereof.

As illustrated in FIG. 17, the internal gear holder 99E serving as the first holder of the driver 90I as the eighth modification example includes a first restrictor 99x serving as a restrictor that restricts movement of the first bearing 97 in one direction (e.g., a rightward direction in FIG. 17) along the thrust direction thereof. The first restrictor 99x contacts an outer race on a right side face of the first bearing 97 (e.g., the ball bearing). Accordingly, the driver 90I positions the first bearing 97 in the one direction (e.g., the rightward direction in FIG. 17) along the thrust direction thereof without employing the retaining ring 129.

The housing 121D serving as the second holder of the driver 90I as the eighth modification example includes a second restrictor 121x as a restrictor that restricts movement of the first bearing 97 in one direction (e.g., a leftward direction in FIG. 17 or a direction opposite to a restricting direction of the first restrictor 99x) along the thrust direction thereof. The second restrictor 121x contacts an outer race on a left side face of the first bearing 97 (e.g., the ball bearing). Accordingly, the driver 90I positions the first bearing 97 in the one direction (e.g., the leftward direction in FIG. 17) along the thrust direction thereof without employing the retaining ring 129.

For example, in the driver 90I as the eighth modification example, the first restrictor 99x of the internal gear holder 99E and the second restrictor 121x of the housing 121D sandwich both ends of the first bearing 97 in the thrust direction thereof, restricting movement of the first bearing 97 bidirectionally (e.g., a forward direction and a backward direction) in the thrust direction thereof.

In the driver 90I as the eighth modification example, the output shaft 96 is press-fitted into an inner diameter portion of the first bearing 97, positioning the first bearing 97 in the driver 90I in the thrust direction of the first bearing 97.

With the driver 90I having the construction described above also, the two bearings, that is, the first bearing 97 and the second bearing 98, rotatably support the output shaft 96. Thus, the driver 90I suppresses tilting of the output shaft 96 that transmits a driving force to the photoconductive drum 1.

As described above, a driver (e.g., the drivers 90, 90A, 90B, 90C, 90D, 90E, 90F, 90G, 90H, and 90I) according to the embodiments includes a driving source (e.g., the driving motor 91), a sun gear (e.g., the sun gear 92, the first sun gear 92A, and the second sun gear 92B), a planetary gear (e.g., the planetary gear 93, the first planetary gear 93A, and the second planetary gear 93B), an internal gear (e.g., the internal gear 94), a carrier (e.g., the carrier 95, the first carrier 95A, and the second carrier 95B), an output shaft (e.g., the output shaft 96), a first bearing (e.g., the first bearings 97, 97A, and 97B), a first holder (e.g., the internal gear holders 99, 99A, 99B, 99C, 99D, and 99E), a second holder (e.g., the housings 121, 121A, 121B, 121C, and 121D), and a second bearing (e.g., the second bearings 98 and 98A).

The driving source drives and rotates the sun gear. The planetary gear meshes with the sun gear. The internal gear meshes with the planetary gear. The carrier rotatably supports the planetary gear. The carrier is combined with the output shaft that has a central axis that is coaxially aligned with a central axis of each of the sun gear and the internal gear. The first bearing rotatably supports the output shaft. The first holder includes an inner circumferential portion (e.g., the inner circumferential portions 99a, 99Ca, and 99 Da) that non-rotatably supports the first bearing and an outer circumferential portion (e.g., the outer circumferential portions 99b, 99Cb, and 99 Db) that non-rotatably supports the internal gear. The second holder non-rotatably supports the driving source and the first bearing. The second bearing rotatably supports the output shaft and is separated from the driving source farther than the first bearing is. The second holder supports the second bearing directly or indirectly.

Accordingly, the driver and an image forming apparatus (e.g., the image forming apparatus 100) incorporating the driver suppress tilting of the output shaft that transmits a driving force to a driven body (e.g., the photoconductive drum 1).

In the embodiments of the present disclosure, the technology of the present disclosure is applied to the driver 90 installed in the image forming apparatus 100 that forms a color image. Alternatively, the technology of the present disclosure may also be applied to a driver installed in an image forming apparatus that forms a monochrome image.

In the embodiments of the present disclosure, the technology of the present disclosure is applied to the driver 90 that drives and rotates the photoconductive drum 1 serving as the driven body. Alternatively, the technology of the present disclosure may also be applied to a driver that drives and rotates a driven body other than the photoconductive drum 1, for example, the driving roller 16 of the intermediate transfer belt device 15 or the like.

According to the embodiments described above, the output shaft 96 is coupled with the drum shaft 110 mounting the photoconductive drum 1. However, a method for transmitting a driving force from the driver 90 to the photoconductive drum 1 is not limited to the above. For example, the output shaft 96 of the driver 90 may be shared as a drum shaft.

According to the embodiments described above, the motor shaft 91a of the driving motor 91 serving as the driving source mounts the sun gear 92. The driving source drives and rotates the sun gear 92 directly. Alternatively, the driving source may drive and rotate the sun gear 92 indirectly through a gear train or the like.

According to the embodiments described above, the first holder (e.g., the internal gear holder 99), the second holder (e.g., the housing 121), and the third holder (e.g., the sensor holder 122) are separate components, respectively. Alternatively, at least two of the first holder, the second holder, and the third holder may be combined into a single component.

The above-described alternatives also achieve advantages similar to the advantages achieved by the embodiments described above.

The technology of the present disclosure is not limited to the embodiments described above. The embodiments are modified properly to configurations or constructions other than those suggested in the embodiments described above within the scope of the technology of the present disclosure. The number, the position, the shape, and the like of the elements and the components described above are not limited to those suggested in the embodiments described above and are modified to the number, the position, the shape, and the like that are appropriate to achieve the technology of the present disclosure.

According to the embodiments described above, the image forming apparatus 100 is a printer. Alternatively, the image forming apparatus 100 may be a copier, a facsimile machine, a multifunction peripheral (MFP) having at least two of copying, printing, scanning, facsimile, and plotter functions, or the like.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A driver comprising:
a sun gear;
a driving source to drive and rotate the sun gear;
a planetary gear meshing with the sun gear;
an internal gear meshing with the planetary gear;
an output shaft having a central axis that is coaxially aligned with a central axis of each of the sun gear and the internal gear;
a carrier supporting the planetary gear rotatably, the carrier combined with the output shaft;
a first bearing supporting the output shaft rotatably;
a first holder including:
an inner circumferential portion supporting the first bearing non-rotatably; and
an outer circumferential portion supporting the internal gear non-rotatably;
a second bearing separated from the driving source farther than the first bearing is, the second bearing supporting the output shaft rotatably; and
a second holder supporting the driving source and the first bearing non-rotatably, the second holder supporting the second bearing.

2. The driver according to claim 1,
wherein the second holder supports the second bearing directly.

3. The driver according to claim 1, further comprising a third holder supported by the second holder stationarily,
wherein the second holder supports the second bearing indirectly through the third holder.

4. The driver according to claim 3,
wherein the second holder has a coefficient of thermal expansion that is equivalent to a coefficient of thermal expansion of the third holder.

5. The driver according to claim 3, further comprising:
an encoder wheel interposed between the first bearing and the second bearing, the encoder wheel combined with the output shaft, the encoder wheel having a pattern; and
an encoder sensor supported by the third holder, the encoder sensor to detect the pattern of the encoder wheel.

6. The driver according to claim 3, further comprising:
an encoder wheel interposed between the first bearing and the second bearing, the encoder wheel combined with the output shaft, the encoder wheel having a pattern; and
an encoder sensor supported by the second holder, the encoder sensor to detect the pattern of the encoder wheel,
wherein the third holder covers the encoder wheel and the encoder sensor.

7. The driver according to claim 1,
wherein the first holder has a coefficient of thermal expansion that is equivalent to a coefficient of thermal expansion of the internal gear.

8. The driver according to claim 1,
wherein the second holder has a rigidity that is greater than a rigidity of the first holder.

9. The driver according to claim 1, further comprising:
an encoder wheel combined with the output shaft, the encoder wheel having a pattern; and
an encoder sensor supported by the second holder, the encoder sensor to detect the pattern of the encoder wheel.

10. The driver according to claim 1,
wherein the second holder covers the internal gear.

11. The driver according to claim 1, further comprising a noise absorber interposed between the second holder and the internal gear.

12. The driver according to claim 1,
wherein the first holder further includes a restrictor to restrict movement of the first bearing in one direction along a thrust direction of the first bearing.

13. The driver according to claim 1,
wherein the second holder includes a restrictor to restrict movement of the first bearing in one direction along a thrust direction of the first bearing.

14. The driver according to claim 1,
wherein the first holder further includes a first restrictor to restrict movement of the first bearing in a first direction along a thrust direction of the first bearing, and
wherein the second holder includes a second restrictor to restrict movement of the first bearing in a second direction opposite to the first direction.

15. The driver according to claim 1, further comprising another first bearing disposed adjacent to the first bearing, said another first bearing supported by the second holder.

16. The driver according to claim 15,
wherein said another first bearing is supported by the first holder.

17. The driver according to claim 1,
wherein the second holder includes a housing.

18. A driver comprising:
a driving motor to generate a driving force, the driving motor including a motor shaft;
a mounting plate mounting the driving motor stationarily;
an output shaft having a center of rotation disposed on a substantially identical, hypothetical straight line shared with a center of rotation of the motor shaft of the driving motor;
a gear reducer to decrease a rotational speed of the driving motor, the gear reducer to transmit the driving force generated by the driving motor to the output shaft;
a first bearing supporting the output shaft rotatably;
a first holder including:
an inner circumferential portion supporting the first bearing non-rotatably; and
an outer circumferential portion supporting the gear reducer non-rotatably;
a second bearing separated from the driving motor farther than the first bearing is, the second bearing supporting the output shaft rotatably; and
a second holder supporting the mounting plate and one of the first bearing, the first holder, and the gear reducer non-rotatably, the second holder supporting the second bearing.

19. An image forming apparatus comprising:
a driven body; and
a driver to drive and rotate the driven body,
the driver including:
a sun gear;
a driving source to drive and rotate the sun gear;
a planetary gear meshing with the sun gear;
an internal gear meshing with the planetary gear;
an output shaft having a central axis that is coaxially aligned with a central axis of each of the sun gear and the internal gear;
a carrier supporting the planetary gear rotatably, the carrier combined with the output shaft;
a first bearing supporting the output shaft rotatably;
a first holder including:
an inner circumferential portion supporting the first bearing non-rotatably; and
an outer circumferential portion supporting the internal gear non-rotatably;
a second bearing separated from the driving source farther than the first bearing is, the second bearing supporting the output shaft rotatably; and
a second holder supporting the driving source and the first bearing non-rotatably, the second holder supporting the second bearing.

20. The image forming apparatus according to claim 19,
wherein the driven body includes a photoconductive drum.
